(19) United States
(12) Patent Application Publication
(10) Pub. No.: US 2014/0203220 A1
(43) Pub. Date: Jul. 24, 2014

(54) ELECTRODE FOR A LI-ION BATTERY HAVING A POLYETHER-SILOXANE COPOLYMER AS BINDER

(71) Applicant: Wacker Chemie AG, Muenchen (DE)

(72) Inventors: Peter GIGLER, Dachau (DE); Stefan HAUFE, Neubiberg (DE); Juergen STOHRER, Pullach (DE)

(73) Assignee: Wacker Chemie AG, Muenchen (DE)

(21) Appl. No.: 14/134,776

(22) Filed: Dec. 19, 2013

(30) Foreign Application Priority Data
Jan. 18, 2013 (DE) 10 2013 200 750.7

(51) Int. Cl. H01M 4/62

(52) U.S. Cl. CPC H01M 4/622
USPC 252/511; 528/31; 252/500

(57) ABSTRACT

The object of the invention is an electrode for a Li-ion battery, which contains a crosslinked polyether-siloxane copolymer (V), which can be prepared by crosslinking of siloxane macromers (S) having the average general formula (1):

HₐR¹_{b}SiO_{(4-a-b)/2} (1),

where R¹ is a monovalent, SiC-bonded C₁-C₁₈ hydrocarbon radical which is free of aliphatic carbon-carbon multiple bonds and a and b are nonnegative integers, with the proviso that 0.5<(a+b)<3.0 and 0<a<2, and that at least two silicon-bonded hydrogen atoms are present per molecule, by means of polyether macromers (P) containing at least two alkenyl groups per molecule and optionally further compounds (W) containing alkenyl groups, with polyethylene glycols functionalized by one allyl group being excepted from the compounds (W) as binder; and also a process for preparing a crosslinked polyether-siloxane copolymer (V) as binder for the electrode in a Li-ion battery in a crosslinking step.

### BACKGROUND OF THE INVENTION

The invention relates to an electrode for a Li-ion battery, which contains a crosslinked polyether-siloxane copolymer composed of polyether units and siloxane units as binder.

The development of higher-performance electrode materials for Li-ion batteries, in particular anode materials, at the same time requires the development of compatible binder systems. The PVDF used for graphite electrodes is not suitable for use in Si-containing electrodes because of its chemical instability. This is reflected in poor electrochemical cycling behavior.

Binder systems which can be processed in an aqueous medium, for example, Na-CMC, polyvinyl alcohols or acrylates, have been described as an alternative. Because of their reactivity toward the lithiated (loaded) active material, for example Li-silicide, or the usually protic solvent used for processing, these are not suitable for the processing of Li-laden active materials.

US 2012/0153219 describes the use of siloxane-containing binders. A description is given of, inter alia, siloxanes containing Si—H groups, and having flexible polyether side chains, which are bound at one end and are crosslinked by means of bifunctional polyether units via hydrosilylation in a further process step. The polyether side chains which are bound at one end are said to make Li-ion transport possible due to their mobility.

The uncrosslinked binders described in US 2012/0153219 display significantly improved cyclic behavior in Si anodes compared to the conventionally used PVDF. A substantial disadvantage of the binders described in US 2012/0153219 is the preparation of the side-chain-modified siloxanes containing Si—H groups, which precedes the actual crosslinking and represents an additional process step.

It was an object of the invention to provide an electrochemically and chemically stable binder system which can be prepared in a simple way.

### DESCRIPTION OF THE INVENTION

The invention provides an electrode for a Li-ion battery, which contains a crosslinked polyether-siloxane copolymer (V), which can be prepared by crosslinking of siloxane macromers (S) having the average general formula (1)

HₐR¹_{b}SiO_{(4-a-b)/2} (1),

where

R¹ is a monovalent, SiC-bonded C₁-C₁₈ hydrocarbon radical which is free of aliphatic carbon-carbon multiple bonds and

a and b are nonnegative integers,

with the proviso that 0.5<(a+b)<3.0 and 0<a<2, and that at least two silicon-bonded hydrogen atoms are present per molecule,

by means of polyether macromers (P) containing at least two alkenyl groups per molecule and optionally further compounds

(W) containing alkenyl groups, with polyethylene glycols functionalized by one allyl group being excepted from the compounds (W), as binder.

The crosslinked polyether-siloxane copolymer (V) is highly suitable as electrode binder in Li-ion batteries and can be copolymerized in only one process step by crosslinking of siloxane macromers (S) by means of polyether macromers (P) and optionally further compounds (W).

It has surprisingly been found that flexible polyether side chains such as those in US 2012/0153219, which require an additional preparation step, are not necessary. The natural swellability in the electrolyte is sufficient for ion conduction.

The crosslinked polyether-siloxane copolymer (V) displays a high electrochemical stability and is stable toward reducing agents, in particular toward lithium silicide, and is thus also suitable for use in Si-containing anodes. Furthermore, the siloxane macromers (S) and polyether macromers (P) are likewise stable, which makes it possible to use Li-laden active materials, such as lithium silicide.

The electrode is preferably produced by crosslinking of the siloxane macromers (S) and polyether macromers (P) and optionally compounds (W) in the presence of active materials and also further components of the electrode.

The crosslinked polyether-siloxane copolymer (V) is preferably prepared by crosslinking of silicone macromers (S), selected from among linear, branched, cyclic and three-dimensionally crosslinked polysiloxanes.

Examples of radicals R¹ in the general formula (1) are alkyl radicals, such as the methyl, ethyl, n-propyl, isopropyl, n-butyl, isobutyl, tert-butyl, n-pentyl, isopentyl, neopentyl, tert-pentyl radical, hexyl radicals, such as the n-hexyl radical, heptyl radicals, such as the n-heptyl radical, octyl radicals, such as the n-octyl radical and isooctyl radicals, such as the 2,2,4-trimethylpentyl radical, nonyl radicals, such as the n-nonyl radical, decyl radicals, such as the n-decyl radical; cycloalkyl radicals, such as cyclopentyl, cyclohexyl, 4-ethylcyclohexyl, cycloheptyl radicals, norbornyl radicals and methylcyclohexyl radicals; aryl radicals, such as the phenyl, biphenylyl, naphthyl radical; alkaryl radicals, such as the o-, m-, p-tolyl radicals and ethylphenyl radicals; aralkyl radicals, such as the benzyl radical, the alpha- and β-phenylethyl radical.

R¹ preferably has from 1 to 6 carbon atoms. Particular preference is given to methyl and phenyl.

Preference is given to using siloxane macromers (S) containing three or more SiH bonds per molecule. When siloxane macromers (S) having only two SiH bonds per molecule are used, it is advisable to use polyether macromers (P) which have at least three alkenyl groups per molecule.

The hydrogen content of the siloxane macromers (S), which relates exclusively to the hydrogen atoms bound directly to silicon atoms, is preferably in the range from 0.002 to 1,7% by weight of hydrogen, preferably from 0.1 to 1.7% by weight of hydrogen.

The siloxane macromers (S) preferably contain at least three and not more than 600 silicon atoms per molecule. Preference is given to using SiH-organosilicon compounds (S), containing from 4 to 200 silicon atoms per molecule.

Particularly preferred siloxane macromers (S) are linear polyorganosiloxanes of the general formula (2)

(HR²₂SiO_{1/2})ₛ(R²₃SiO_{1/2})ₜ(HR²SiO_{2/2})ᵤ(R²₂SiO_{2/2})ᵥ (2),

where

R² is as defined for R¹ and the nonnegative integers s, t, u and v fulfill the following relationships: (s+t)=2, (s+u)>2, 5<(u+v)<1000 and 0.1<u/(u+v)1.

Preference is given to s being 0.

Preference is given to 10<(u+v)<100

The SiH-functional siloxane macromers (S) are preferably present in such an amount in the mixture of siloxane macromers (S) with polyether macromers (P) and optionally compounds (W), that the molar ratio of SiH groups to alkenyl groups is from 0.1 to 2, in particular from 0.3 to 1.0.

Preference is given to using from 0.1 to 50, particularly preferably from 0.5 to 15, parts by weight of siloxane macromers (S) per 100 parts by weight of active material.

Unsaturated polyalkylene oxides which have at least 3 alkylene oxide units and contain at least two terminal unsaturated groups are preferred as polyether macromers (P).

The polyether macromers (P) can be linear or branched.

The unsaturated group is preferably selected from among the groups vinyl, allyl, methallyl, dimethylvinylsilyl and styryl. The unsaturated group is preferably located at the end of the chain. The alkylene oxide units in the polymer preferably have from 1 to 8 carbon atoms and can be identical or different and can be distributed randomly or in blocks. Possible alkylene oxide units are preferably ethylene oxide, propylene oxide, butylene oxide, with particular preference being given to ethylene oxide and propylene oxide and also mixtures thereof. Preference is given to chain lengths of from 3 to 1000, in particular from 3 to 100, repeating units.

Most preferred unsaturated polyethers are polyethylene glycol divinyl ether, polyethylene glycol diallyl ether, polyethylene glycol dimethallyl ether, polypropylene glycol bis(dimethylvinylsilyl) ether, with the unsaturated groups in each case being terminal.

Preference is given to using from 0.1 to 50, particularly preferably from 0.5 to 15, parts by weight of polyether macromers (P) per 100 parts by weight of active material.

Compounds (W) can, for example, be hydrolyzable vinylsilanes, alkenyl-terminated alcohols, carboxylic acids, carboxylic esters or epoxides.

Preferred compounds (W) are vinyltrimethoxysilane, allyl alcohol, methacrylic acid and methyl acrylate.

Preference is given to using from 0 to 5, particularly preferably from 0 to 3, parts by weight of compounds (W) per 100 parts by weight of active material. In a preferred embodiment, no compounds (W) containing alkenyl groups are used.

The crosslinking of siloxane macromers (S) by means of polyether macromers (P) and optionally compounds (W) can be catalyzed by hydrosilylation catalysts or proceed by a free radical mechanism.

Crosslinking is preferably catalyzed by hydrosilylation catalysts.

As free-radical formers for free-radical crosslinking, it is possible to use peroxides, in particular organic peroxides.

Examples of organic peroxides are peroxyketal, e.g. 1,1-bis(tert-butylperoxy)-3,3,5-trimethylcyclohexane, 2,2-bis(tert-butylperoxy)butane; acyl peroxides, such as for example acetyl peroxide, isobutyl peroxide, benzoyl peroxide, di(4-methylbenzoyl) peroxide, bis(2,4-dichlorobenzoyl) peroxide; dialkyl peroxides, such as di-tert-butyl peroxide, tert-butyl cumyl peroxide, dicumyl peroxide, 2,5-dimethyl-2,5-di(tert-butylperoxy)hexane; and peresters such as tert-butylperoxyisopropyl carbonate.

When peroxides are used for crosslinking, the content of peroxides is preferably selected so that the mixture containing the constituents to be crosslinked, viz. siloxane macromers (S), polyether macromers (P), optionally compounds (W), and also an active material has a peroxide content of 0.05-8% by weight, preferably 0.1-5% by weight and particularly preferably 0.5-2% by weight, in each case based on the total weight of siloxane macromers (S), polyether macromers (P) and optionally compounds (W).

As hydrosilylation catalysts for the crosslinking of the siloxane macromers (S) by means of the polyether macromers (P) and optionally compounds (W), it is possible to use all known catalysts which catalyze the hydrosilylation reactions proceeding during the crosslinking of addition-crosslinking silicone compositions.

As hydrosilylation catalysts, use is made of in particular metals and compounds thereof from the group consisting of platinum, rhodium, palladium, ruthenium and iridium. Preference is given to using platinum and platinum compounds.

Preferred hydrosilylation catalysts are Pt(0) complexes, in particular a divinyltetramethyldisiloxane-platinum(0) complex or H₂PtCl₆.

Particular preference is also given to platinum compounds which are soluble in polyorganosiloxanes. As soluble platinum compounds, it is possible to use, for example, the platinum-olefin complexes of the formulae (PtCl₂.olefin)₂ and H(PtCl₂.olefin), with preference being given to using alkenes having from 2 to 8 carbon atoms, e.g. ethylene, propylene, isomers of butene and octene, or cycloalkenes having from 5 to 7 carbon atoms, e.g. cyclopentene, cyclohexene and cycloheptene. Further soluble platinum catalysts are the platinum-cyclopropane complex of the formula (PtCl₂C₃H₆)₂, the reaction products of hexachloroplatinic acid with alcohols, ethers and aldehydes or mixtures thereof or the reaction product of hexachloroplatinic acid with methylvinylcyclotetrasiloxane in the presence of sodium bicarbonate in ethanolic solution. Particular preference is given to complexes of platinum with vinylsiloxanes, such as sym-divinyltetramethyldisiloxane.

The hydrosilylation catalyst can be used in any desired form, for example, in the form of microcapsules containing hydrosilylation catalyst or in the form of polyorganosiloxane particles.

The content of hydrosilylation catalysts is preferably selected so that the mixture containing the constituents to be crosslinked, viz. siloxane macromers (S), polyether macromers (P) and optionally compounds (W), and also active material has a Pt content of 0.1 to 200 ppm by weight, in particular from 0.5 to 120 ppm by weight, in each case based on the total weight of siloxane macromers (S), polyether macromers (P) and optionally compounds (W).

In the presence of hydrosilylation catalysts, the use of inhibitors is preferred. Examples of customary inhibitors are acetylenic alcohols such as 1-ethinyl-1-cyclohexanol, 2-methyl-3-butyn-2-ol and 3,5-dimethyl-1-hexyn-3-ol, 3-methyl-1-dodecyn-3-ol, polymethylvinylcyclosiloxanes, such as 1,3,5,7-tetravinyltetramethyltetracyclosiloxane, low molecular weight silicone oils containing (CH₃)(CHR═CH)SiO_{2/2} groups and optionally R₂(CHR═CH)SiO_{1/2} end groups, for example divinyltetramethyldisiloxane, tetravinyldimethyldisiloxane, trialkyl cyanurates, alkyl maleates, such as diallyl maleate, dimethyl maleate and diethyl maleate, alkyl fumarates, such as diallyl fumarate and diethyl fumarate, organic hydroperoxides, such as cumene hydroperoxide, tert-butyl hydroperoxide and pinane hydroperoxide, organic peroxides, organic sulfoxides, organic amines, diamines and amides, phosphates and phosphites, nitriles, triazoles, diaziridines and oximes. The action of these inhibitors depends on their chemical structure, so that the suitable inhibitor and the content in the mixture to be crosslinked has to be determined individually.

The content of inhibitors in the mixture to be crosslinked is preferably from 0 to 50,000 ppm by weight, particularly preferably from 20 to 2000 ppm by weight, in particular from 100 to 1000 ppm by weight, in each case based on the total weight of siloxane macromers (S), polyether macromers (P) and optionally compounds (W).

Crosslinking can be carried out in one or more solvents, in particular aprotic solvents. If aprotic solvents are used, preference is given to solvents or solvent mixtures having a boiling point or boiling range of up to 210° C. at 0.1 MPa. Examples of such solvents are ethers, such as dioxane, tetrahydrofuran, diethyl ether, diisopropyl ether, diethylene glycol dimethyl ether; chlorinated hydrocarbons, such as dichloromethane, trichloromethane, tetrachloromethane, 1,2-dichloroethane, trichloroethylene; hydrocarbons, such as pentane, n-hexane, hexane isomer mixtures, heptane, octane, naphtha, petroleum ether, benzene, toluene, xylenes; esters, such as ethyl acetate, butyl acetate, propyl propionate, ethyl butyrate, ethyl isobutyrate; nitrobenzene and N-methyl-2-pyrrolidone, or mixtures of these solvents.

The temperature during crosslinking is preferably from 20° C. to 150° C., in particular from 40° C. to 90° C.

The duration of crosslinking is in the range from 0 to 5 hours, preferably from 0.5 to 3 hours.

The pressure during crosslinking is preferably from 0.010 to 1 MPa (abs.), in particular from 0.05 to 0.1 MPa (abs.).

The active material for the electrode preferably consists of elements, selected from among carbon, silicon, lithium, tin, titanium and oxygen. Preferred active materials are silicon, silicon oxide, graphite, silicon-carbon composites, tin, lithium, lithium-titanium oxide and lithium silicide. Particular preference is given to graphite and silicon and also the silicon-carbon composites.

When silicon powder is used as active material, the primary particle size is 1-500 nm, preferably 50-200 nm.

The electrode can additionally contain conductive carbon black.

The electrode preferably contains from 1 to 20, particularly preferably from 2 to 15, parts by weight of conductive carbon black per 100 parts by weight of active material.

The electrode can contain further components in addition to siloxane macromers (S), polyether macromers (P), active material, compounds (W), an organic solvent and conductive carbon black.

Further components can be, for example, additional components suitable as binder, e.g. styrene-butadiene-rubber and polyvinylidene fluoride or components which increase the conductivity, e.g. carbon nanotubes (CNT) and carbon fibers.

In a preferred embodiment, the mixture which is usually referred to as electrode ink or paste and can contain the constituents to be crosslinked viz. siloxane macromers (S), polyether macromers (P), optionally compounds (W), and also active material and optionally conductive carbon black and also further components is spread in a dry layer thickness of from 2 μm to 500 μm, preferably from 10 μm to 300 μm, on a copper foil or another current collector by means of a doctor blade. Other coating processes such as spin-coating, dip coating, painting or spraying can likewise be used. Before coating of the copper foil with the mixture, the copper foil can be treated by means of a commercial primer, e.g. based on polymer resins. This increases the adhesion to the copper but itself has virtually no electrochemical activity.

The above-described mixture, which represents the electrode material, is preferably dried to constant weight. The drying temperature depends on the components employed and the solvent used. It is preferably in the range from 20° C. to 300° C., particularly preferably from 50° C. to 150° C.

Crosslinking can take place before, during or after drying.

An electrode can be a cathode or an anode. Preference is given to an anode. Particular preference is given to a silicon anode.

All above symbols in the above formulae have their meanings independently of one another in each case. In all formulae, the silicon atom is tetravalent. The sum of all constituents of the silicone mixture is 100% by weight.

In the following examples, unless indicated otherwise, all amounts and percentages are by weight, all pressures are 0.10 MPa (abs.), and all temperatures are 20° C.

1) Synthesis of the Pure Binder and Solubility Test

3.83 g of bis(dimethylvinylsilyl)polypropylene glycol and 2.64 g of H-siloxane (of the general formula (2) where R²=methyl, t=2, u is on average 24, v is on average 48) were weighed together with stabilized divinyltetramethyldisiloxane-platinum(0) complex (100 ppm of Pt based on the total mass of siloxane and polyether) into a 100 ml vessel and mixed well. The mixture was subsequently poured into a Teflon dish and crosslinked at 70° C. for 4 hours in a drying oven.

The transparent film was subsequently laid in a mixture of dimethyl carbonate/ethylene carbonate (1:1 w/w) for 24 hours. After the swollen film had been taken out, the solvent was removed leaving no residue, which allowed conclusions regarding solubility of the binder in the electrolyte solvent to be drawn.

2) Synthesis of a Model Compound

3.73 g of heptamethyltrisiloxane and divinyltetramethyldisiloxane-platinum(0) (100 ppm of Pt based on the total mass of siloxane and polyether) were placed in a stirred apparatus which had been made inert and was provided with a magnetic stirrer bar and reflux condenser. This mixture was heated to 70° C. (oil bath), 4.85 g of bis(dimethylvinylsilyl)polypropylene glycol were added dropwise and the mixture was stirred for 1 hour at 70° C.

3) Stability Test of the Model Compound in the Presence of Lithium Silicide

In a glove box (<1 ppm H₂O, O₂) 10 mg of Li₁₅Si₄ were suspended in 5 ml of toluene and added dropwise to 1 g of the model compound from example 2. No gas evolution and discoloration of the solution were observed. NMR analysis indicated no decomposition of the model compound used.

4) Stability Test of bis(dimethylvinylsilyl)polypropylene Glycol in the Presence of Lithium Silicide

In a glove box (<1 ppm H₂O, O₂), 10 mg of Li₁₅Si₄ were suspended in 5 ml of toluene and added dropwise to 1 g of bis(dimethylvinylsilyl)polypropylene glycol. No gas evolution and discoloration of the solution were observed. NMR analysis indicated no decomposition of the bis(dimethylvinylsilyl)polypropylene glycol.

5) Stability Test of H-siloxane in the Presence of Lithium Silicide

In a glove box (argon atmosphere), 10 mg of Li₁₅Si₄ were suspended in 5 ml of toluene and added dropwise to 1 g of H-siloxane (from example 1). No gas evolution and discoloration of the solution were observed. NMR analysis indicated no decomposition of the H-siloxane.

6) Production of a Graphite Anode 86.8% of graphite (KS6L C), 7.4% of conductive carbon black (Super P), 5.8% of binder (consisting of equal parts of bis(dimethylvinylsilyl)polypropylene glycol and H-siloxane from example 1 and also stabilized divinyltetramethyldisiloxane-platinum(0) complex (100 ppm of Pt based on the total mass of siloxane and polyether) were dispersed in 6.49 g of toluene by means of an Ultra-Turrax.

After degassing, the dispersion was applied by means of a film drawing frame having a gap height of 0.10 mm (Erichsen, model 360) to a copper foil (Schlenk Metallfolien, SE-Cu58) having a thickness of 0.030 mm. The electrode coating produced in this way was subsequently crosslinked and dried at 70° C. for 3 hours. The average weight per unit area of the electrode coating was 0.47 mg/cm².

7) Electrochemical Measurements

The electrochemical studies were carried out on a half-cell in a three-electrode arrangement (zero-current potential measurement). The electrode coating from example 6 was used as working electrode, lithium foil (Rockwood Lithium, thickness 0.5 mm) was used as reference electrode and counterelectrode. A 6-layer nonwoven stack (Freudenberg Vliesstoffe, FS2226E) impregnated with 100 μl of electrolyte, served as separator. The electrolyte used consisted of a 1 molar solution of lithium hexafluorophosphate in a 1:1 (w/w) mixture of ethylene carbonate and dimethyl carbonate. The construction of the cell was carried out in a glove box (<1 ppm H₂O, O₂), and the water content in the dry matter of all components used was below 20 ppm.

The electrochemical testing was carried out at 20° C. Potential limits used were 40 mV and 1.0 V vs. Li/Li⁺. Charging and lithiation of the electrode was carried out under cc/cv (constant current/constant voltage) conditions, at a constant current and after reaching the voltage limit at constant voltage until the current became less than 15 mA/g. The discharging and delithiation of the electrode was carried out under cc (constant current) conditions at a constant current until the voltage limits had been reached. The specific current selected was based on the weight of the electrode coating.

The electrode coating from example 6 has a reversible initial capacity of about 280 mAh/g and after 100 charging/discharging cycles still has about 90% of its original capacity, which corresponds to an average coulomb efficiency of 99.9%.

8) Production of a Silicon Anode

79.4% of silicon, 7.9% of conductive carbon black (Super P), 12.6% of binder (consisting of equal parts of bis(dimethylvinylsilyl)polypropylene glycol and H-siloxane (of the general formula (2) where R²=methyl, t=2, u is on average 12, v is on average 80) and stabilized divinyltetramethyldisiloxane-platinum(0) complex (100 ppm of Pt based on the total mass of siloxane and polyether) were dispersed in 5 g of toluene by means of a high-speed mixer. After degassing, the dispersion was applied by means of a film drawing frame having a gap height of 0.10 mm (Erichsen, model 360) to a copper foil (Schlenk Metallfolien, SE-Cu58) having a thickness of 0.030 mm. The electrode coating produced in this way was subsequently crosslinked and dried at 70° C. for 3 hours. The average weight per unit area of the electrode coating was 1.68 mg/cm².

What is claimed is:

1. An electrode for a Li-ion battery, which contains a crosslinked polyether-siloxane copolymer, which can be prepared by crosslinking of siloxane macromers having the average general formula (1)
HₐR¹_{b}SiO_{(4-a-b)/2} (1),
where
R¹ is a monovalent, SiC-bonded C₁-C₁₈ hydrocarbon radical which is free of aliphatic carbon-carbon multiple bonds and
a and b are nonnegative integers,
with the proviso that 0.5<(a+b)<3.0 and 0<a<2, and that at least two silicon-bonded hydrogen atoms are present per molecule,
by use of polyether macromers containing at least two alkenyl groups per molecule and optionally further compounds containing alkenyl groups, with polyethylene glycols functionalized by one allyl group being excepted from the compounds as binder.

2. The electrode as claimed in claim 1, which can be produced by crosslinking the siloxane macromers and polyether macromers and optionally compounds in the presence of active material, forming the polyether-siloxane copolymer.

3. The electrode as claimed in claim 1, wherein linear polyorganosiloxanes of the general formula (2)
(HR²₂SiO_{1/2})ₛ(R²₃SiO_{1/2})ₜ(HR²SiO_{2/2})ᵤ(R²₂SiO_{2/2})ᵥ (2),
where
R² is a monovalent, SiC-bonded C₁-C₁₈ hydrocarbon radical which is free of aliphatic carbon-carbon multiple bonds and
the nonnegative integers s, t, u and v fulfill the following relationships: (s+t)=2, (s+u)>2, 5<(u+v)<1000 and 0.1<u/(u+v)≦1
are used as silicone macromers.

4. The electrode as claimed in claim 1, wherein unsaturated polyalkylene oxides which have at least 3 alkylene oxide units and contain at least two terminal unsaturated groups are used as polyether macromers.

5. The electrode as claimed in claim 1, wherein crosslinking of the siloxane macromers by use of the polyether macromers and optionally compounds, is catalyzed by hydrosilylation catalysts or proceeds by a free radical mechanism.

6. The electrode as claimed in claim 5, wherein Pt(0) complexes are used as hydrosilylation catalysts.

7. The electrode as claimed in claim 1, which is an anode.

8. The electrode as claimed in claim 7, wherein an active material for the anode comprises elements selected from the group consisting of carbon and silicon.

9. The electrode as claimed in claim 2, wherein linear polyorganosiloxanes of the general formula (2)
(HR²₂SiO_{1/2})ₛ(R²₃SiO_{1/2})ₜ(HR²SiO_{2/2})ᵤ(R²₂SiO_{2/2})ᵥ (2),
where
R² is a monovalent, SiC-bonded C₁-C₁₈ hydrocarbon radical which is free of aliphatic carbon-carbon multiple bonds and
the nonnegative integers s, t, u and v fulfill the following relationships: (s+t)=2, (s+u)>2, 5<(u+v)<1000 and 0.1<u/(u +v)1
are used as silicone macromers.

10. The electrode as claimed in claim 9, wherein unsaturated polyalkylene oxides which have at least 3 alkylene oxide units and contain at least two terminal unsaturated groups are used as polyether macromers.

11. The electrode as claimed in claim 10, wherein crosslinking of the siloxane macromers by use of the polyether macromers and optionally compounds, is catalyzed by hydrosilylation catalysts or proceeds by a free radical mechanism.

12. The electrode as claimed in claim 11, wherein Pt(0) complexes are used as hydrosilylation catalysts.

13. The electrode as claimed in claim 12, which is an anode.

14. The electrode as claimed in claim 13, wherein an active material for the anode comprises elements selected from the group consisting of carbon and silicon.

15. A process for preparing a crosslinked polyether-siloxane copolymer as binder for an electrode in a Li-ion battery, in which siloxane macromers having the average general formula (1)
HₐR¹_{b}SiO_{(4-a-b)/2} (1),
where
R¹ is a monovalent, SiC-bonded C₁-C₁₈ hydrocarbon radical which is free of aliphatic carbon-carbon multiple bonds and
a and b are nonnegative integers,
with the proviso that 0.5<(a+b)<3.0 and 0<a<2, and that at least two silicon-bonded hydrogen atoms are present per molecule,
are crosslinked by use of polyether macromers containing at least two alkenyl groups per molecule and optionally further compounds containing alkenyl groups in one process step.
